(19) United States
(12) Patent Application Publication
(10) Pub. No.: US 2005/0125306 A1
(43) Pub. Date: Jun. 9, 2005

(54) Customer quotation system and method thereof

(76) Inventors: Ming-Ta Hsu, Jhubei City (TW); Grace Lin, Palo Alto, CA (US); Joey Huang, Luodong Township (TW); Eric Lin, Hsinchu City (TW)

Correspondence Address: THOMAS, KAYDEN, HOSTEMEYER & RISLEY LLP, 100 GALLERIA PARKWAY, SUITE 1750, ATLANTA, GA, 30339, US

(21) Appl. No.: 10/730,397

(22) Filed: Dec. 8, 2003

(51) Int. Cl. G06F 17/60

(52) U.S. Cl. 705/26

(57) ABSTRACT

A customer quotation system and method thereof are disclosed. In some embodiments, the system creates quoting data tables for products in accordance with original data tables for production. The system then integrates the quoting data tables to create customer requirement tables compatible with customer quotation systems. The system automatically provides product prices, which are derived from the sum of quotes for process technologies when customers create purchase orders.

### BACKGROUND OF THE INVENTION

1. Field of the Invention

The present invention relates to a customer quotation system, and in particular to a customer quotation system converting process technology data and prices to product data tables, compatible with the customer quotation system, to provide customers clear product prices.

2. Description of the Related Art

Buyers in need of goods and services often spend considerable time locating an appropriate vendor. Vendors advertise through various media and by direct sales methods to inform potential buyers of what they sell and how to contact them. Once a buyer identifies a number of vendors, each must be contacted to obtain product or service price and availability thereof. This is time consuming and companies typically rely on experienced purchasing staff to accomplish it.

Business-to-business (B2B) trade is much more complex than end market consumer behavior, although model behavior thereof is similar, involving inquiry, quotation, negotiation, and price confirmation.

Quotation systems are widely used in transaction platforms, such as business-to-business, business-to-consumer (B2C), and consumer-to-consumer (C2C) platforms. Selling prices of products are integrated into the quotation system after products are priced, and customers obtain product prices through a quotation system, and create purchase orders. Generally, vendors market finished products, such as cell phones, allowing simple quotation and negotiation with customers.

However, manufacturing vendors do not provide finished products. In semiconductor manufacturing, for example, products differ with assembly line, and process technologies thereof also vary according to the customer requirements. Further, different process technologies contribute individually to pricing.

Customers receive quotes for products as desired, when creating purchase orders, but multiple process technologies may be involved in manufacturing the finished products. For example, for a cell phone order, process technologies involved can comprise chips embedded therein manufactured by wafer process, display panels thereon manufactured by LCD process, and housings manufactured by injection. These process technologies are provided at different prices, and finished products are quoted according to a sum of quotes for the process technologies. In addition, quotes must consider additional specified process technologies for special customer requirements, such as, for example, processes required by specially requested product finishing or packaging.

Prices for tools, equipment, and materials for production have limitations related to validity and fluctuation, such that product prices change with time in accordance with material availability or supplier strategies. Therefore, quotations related to process technologies are re-configured regularly. Customers also monitor effective dates of product prices provided by vendors to make economically practical purchases, and request prices from vendors again when the effective quote date has passed. Purchasing agents and systems are thus overly burdened by the concerns of such fluctuation.

Customers may also become confused when ordering products by the wide range of processes. For example, if a vendor has product A using process technology 1 and product B using process technology 2, and process technology 1 differs little from the process technology 2, customers wanting to purchase product A may confuse process technology 2 with process technology 1, and mistakenly request product B when creating purchase orders.

Current general-purpose quotation systems between vendors and customers are successful because of simplification of products. In semiconductor manufacturing, customers choose desired products with no consideration of process technologies used therein, such that there are often disputes between vendors and customers. In addition, customers must devote a great deal of time to requesting quotes for processes, yet the results may not be accurate.

### SUMMARY OF THE INVENTION

Accordingly, an object of the present invention is to provide a customer quotation system generating a customer requirement table, automatically providing product prices when customers create purchase orders.

Another object of the present invention is to provide a method for integrating both process technologies and quotation products in creating a customer requirement table.

According to the object shown above, embodiments of the present invention provide a customer quotation system, comprising a data processing module and a data delivery module. The data processing module creates a process technology table, a product quote header table, and a product quote item table from an original product data table, an original process technology table, an original quote header table, and a quote item table separately, using well-know methods. Next, the process technology table, the product quote header table, and the product quote item table are converted to a customer requirement table.

The data delivery module sends the customer requirement table to the customer quotation system, and customers create purchase orders accordingly.

Embodiments of the present invention further provide methods for facilitating customer quotation. First, a process technology table, a product quote header table, and a product quote item table are created from an original product data table, an original process technology table, an original quoting header table, and an original quoting item table separately, using well-know methods.

The process technology table, the product quotation header table, and the product quotation item table are then integrated and converted to a customer requirement table.

Next, the customer requirement table is sent to the customer quotation system, and customers create purchase orders accordingly, in which prices constitute sums of individual process quotes.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic diagram showing the architecture of a customer quotation system according to an embodiment of the present invention;

FIG. 2a is a schematic diagram showing the process technology table according to an embodiment of the present invention;

FIG. 2b is a schematic diagram showing the product quote header table according to an embodiment of the present invention;

FIG. 2c is a schematic diagram showing the product quote item table according to an embodiment of the present invention;

FIG. 3 is a schematic diagram showing the customer requirement table according to an embodiment of the present invention; and

FIG. 4 is a flowchart of the detailed steps of a method for facilitating customer quotation according to an embodiment of the present invention.

### DETAILED DESCRIPTION OF THE INVENTION

The present invention discloses a customer quotation system providing a list of prices to the customer quotation system, thereby providing system-to-system service. While the invention is shown in terms of semiconductor manufacturing and the preferred embodiments, it is to be understood that the invention is not limited thereto.

Various processes and relevant data are necessary for manufacture of a product, and the invention integrates these to satisfy customer requirements.

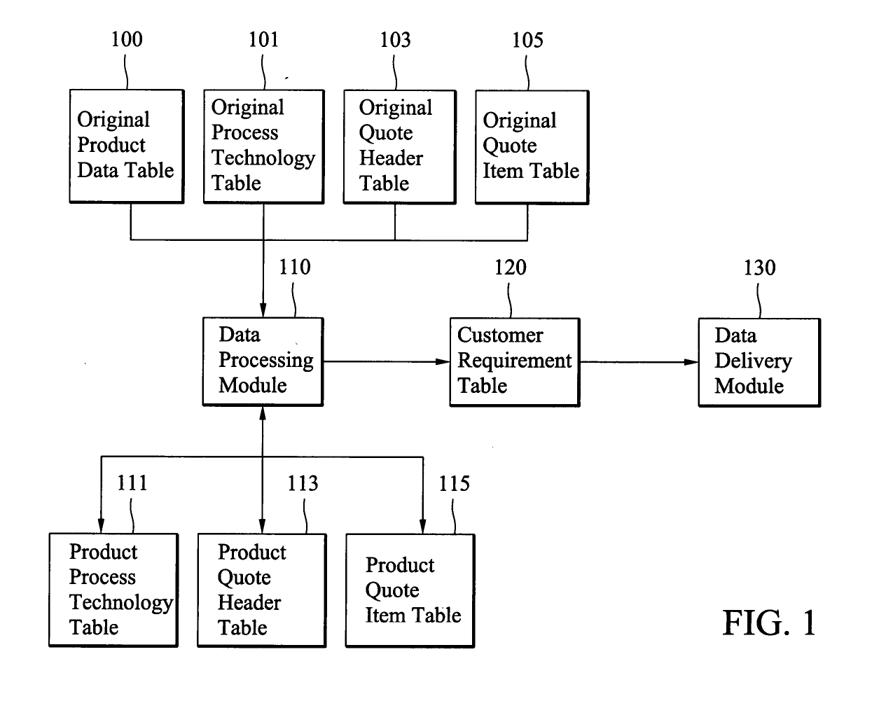

FIG. 1 is a schematic diagram showing the architecture of the customer quotation system according to an embodiment of the present invention.

The architecture comprises a data processing module 110, which converts product and process data to tables suitable for customer quotation system, and a data delivery module 130, which sends the tables to customer quotation systems.

The system analyzes process technologies and data. Process technologies used in semiconductor manufacturing, as an example, comprise photolithography, etching, circuit testing, wafer fabrication, and others, with different products manufactured by different process technologies and/or combinations thereof.

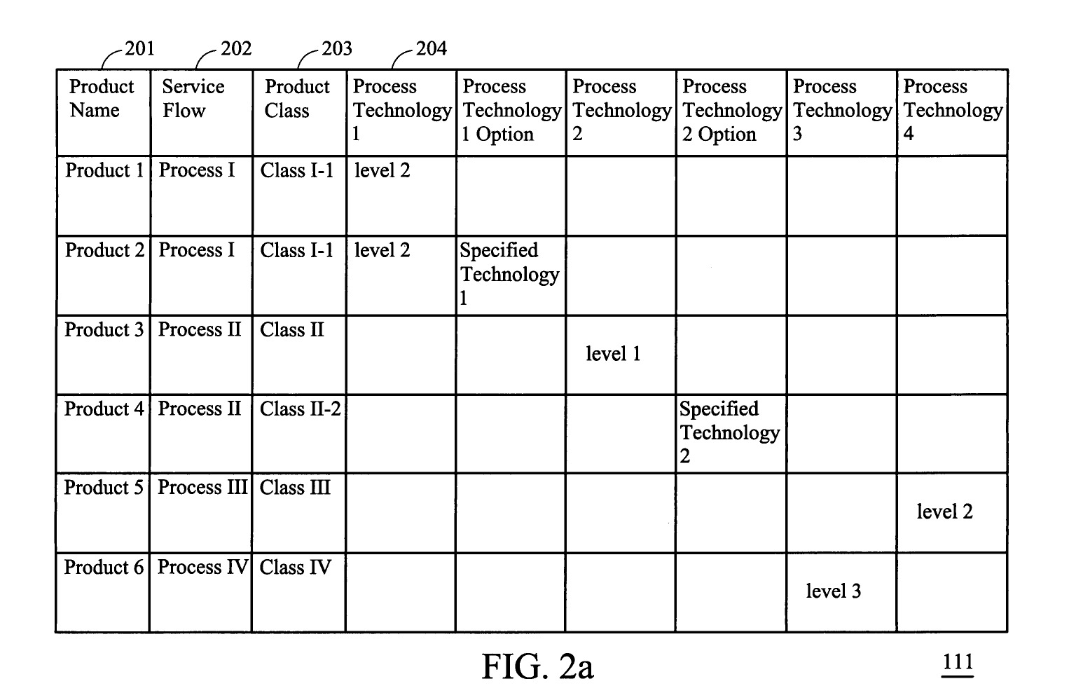

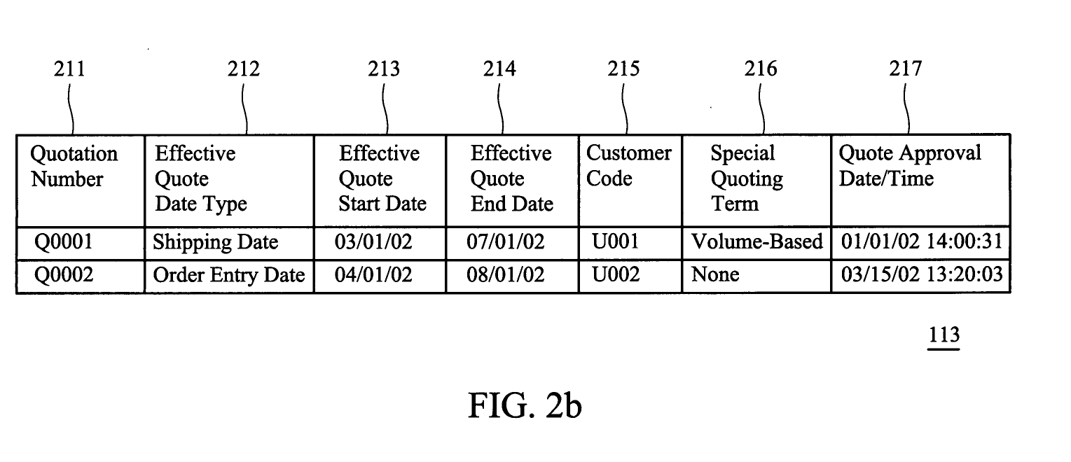

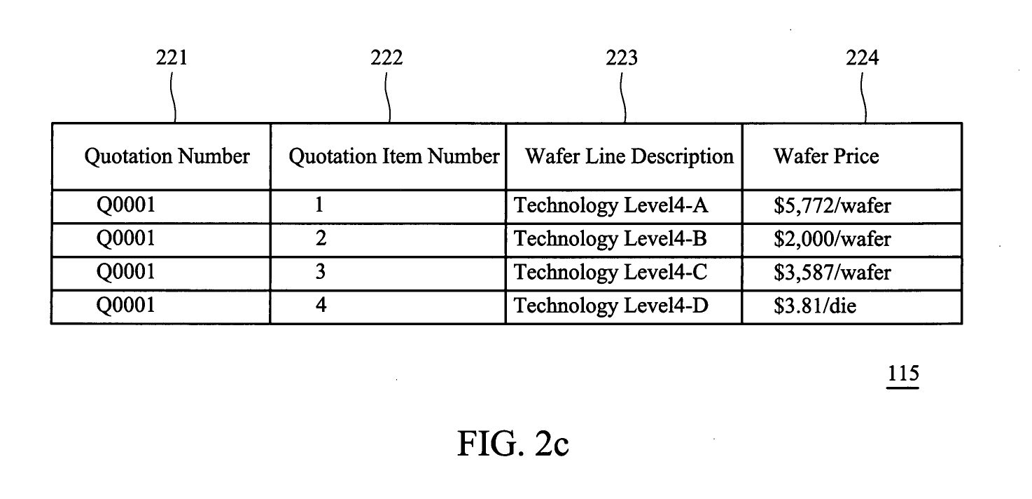

Original product data table 100 lists products manufactured, while original process technology table 101 lists relevant process technologies for the products. Data processing module 110 creates process technology table 111 (as shown in FIG. 2a), listing process technologies that are used. The list of processing technologies comprises specified individual process technologies that correspond to customer requirements.

The process technology table 111 comprises fields that include product name 201, service flow 202, product class 203, and process technology 204. Service flow field 202 shows a process used. The product class field 203 shows a process technology or an optional specified technology used. Other process technology fields therein show different levels of process technologies separately. For example, product 2 is manufactured by process I with level 2 of process technology 1 and specified technology 1 of optional process technology 1. Product 5 is manufactured by process III with level 2 of process technology 4. The fields in the process technology table 111 are not limited to those disclosed here.

In some embodiments, the original quote header table 103 lists effective quote start date, effective quote end date, customer code, and quote approval date and time. The data processing module 110 creates product quote header table 113 (as shown in FIG. 2b) from the original quote header table 103, using well-know methods. The product quote header table 113 comprises fields that include quotation number 211, effective quote date type 212, effective quote start date 213, effective quote end date 214, customer code 215, special quote term 216, and quote approval date and time 217. The effective quote date type field 212 shows effective quote date of a product separated into “shipping date” or “order entry date”. The effective quote start date 213 and effective quote end date 214 fields show the time range of a quote. The fields in the product quote header table 113 are not limited to those disclosed here.

Original quote item table 105 shows quotes for different process technologies for different products, and data processing module 110 creates product quote item table 115 (as shown in FIG. 2c) from the original quote item table 105, using well-know methods. The product quote item table 115 comprises fields that include quotation number 221, quotation item number 222, wafer line description 223, and wafer price 224. The wafer line description field 223 shows levels of process technologies used to process wafers. The wafer price field 224 shows quotes for process technologies corresponding to the wafer line description field 223. The fields in the product quote item table 115 are not limited to those disclosed here.

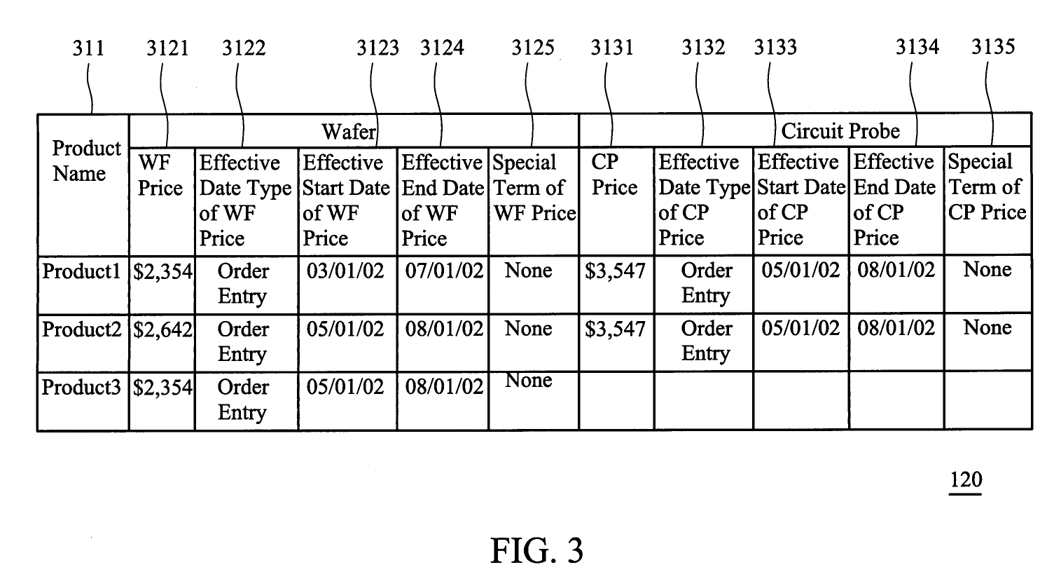

The data processing module 110 converts the process technology table 111, the product quote header table 113, and the product quote item table 115 to the customer requirement table 120 (as shown in FIG. 3). The customer requirement table 120 comprises fields that include product name 311, wafer (WF) price 3121, effective date type of wafer price 3122, effective start date of wafer price 3123, effective end date of wafer price 3124, special term of wafer price 3125, circuit probe (CP) price 3131, effective date type of circuit probe price 3132, effective start date of circuit probe price 3133, effective end date of circuit probe price 3134, and special term of circuit probe price 3135. The fields in the customer requirement table 120 are not limited to those disclosed here

For example, product 1 can be shown as being manufactured by wafer process, with wafer price of $2,354, effective date type of wafer price “Order entry Date”, effective start and end dates of wafer price from Mar. 1, 2002 to Jul. 1, 2002, without special term, using circuit probe process, circuit probe price of $3,547, effective date type of circuit probe price “Order entry Date”, effective start and end dates of circuit probe price from May 1, 2002 to Aug. 1, 2002, and without special terms.

The data delivery module 130 sends the customer requirement table 120 to the customer quotation system, automatically providing product prices when customers create purchase orders.

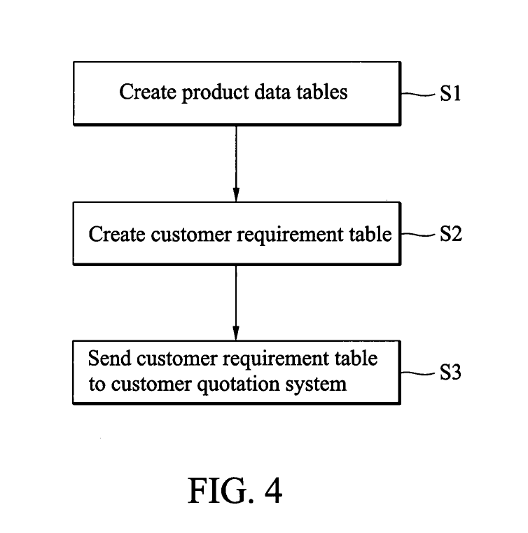

FIG. 4 is a flowchart of the detailed steps of the method of the customer quotation according to an embodiment of the present invention.

In step S1, the system creates product data tables, many of which are related to process technologies for semiconductor manufacturing. The product data tables comprise an original product data table, an original process technology table, an original quote header table, and an original quote item table, in addition to a process technology table, a product quote header table, and a product quote item table. All are created by classification accordingly. The process technology table shows product process technologies, comprising specified process technologies for customer requirements. The product quote header table shows effective quote start date, effective quote end date, customer code, and quote approval date and time. The product quote item table shows quotes for process technologies, with quotes for specified process technologies involved according to special customer requirements.

In step S2, the system creates a customer requirement table. The process technology table, the product quotation header table, and the product quotation item table are integrated, obtaining process technologies and quotes thereof for each product, for conversion to a customer quotation requirement table.

In step S3, the customer requirement table is sent to the customer quotation system to automatically provide product prices and a sum of quotes for process technologies, when customers create purchase orders.

The customer quotation system according to an embodiment of the present invention shares data formats between manufacturing industries and customers thereof. Manufacturing industries convert process technologies and quotes thereof to data tables compatible with customer quotation systems. The system then automatically provides product prices from the data tables when customers create purchase orders, such that customers can save time and decrease error probability in comparing process technologies.

While the invention has been shown by way of example and in terms of the preferred embodiments, it is to be understood that the invention is not limited to those embodiments disclosed here. To the contrary, it is intended to cover various modifications and similar arrangements, as would be apparent to those skilled in the art. Therefore, the scope of the appended claims should be accorded the broadest interpretation so as to encompass all such modifications and similar arrangements.

1. A customer quotation system providing product price information to customers, comprising:
a data processing module configured to create a plurality of product data tables from a plurality of original data tables, wherein the product data tables comprise at least process technology data and product quote data, the data processing module further being configured to integrate and convert the product data tables to a customer requirement table, the data processing module further being configured to obtain a price of a product based on a sum of quotes for process technologies corresponding to the product from the customer requirement table.

2. The system as claimed in claim 1, wherein the original data tables comprise an original product data table and an original process technology table.

3. The system as claimed in claim 2, wherein the product data tables comprise a process technology table created from the original product data table and the original process technology table.

4. The system as claimed in claim 1, wherein the original data tables comprise an original quote header table.

5. The system as claimed in claim 1, wherein the product data tables comprise a product quote header table created from an original quote header table in the original data table.

6. The system as claimed in claim 1, wherein the original data tables comprise an original quote item table.

7. The system as claimed in claim 6, wherein the product data tables comprise a product quote item table created from the original quote item table.

8. The system as claimed in claim 1, wherein the process technology data comprises at least one specified process technology.

9. A method for providing product price information to customers, the method comprising the steps of:
creating a plurality of product data tables from a plurality of original data tables, wherein the product data tables comprise process technology data and product quote data;
integrating and converting the product data tables to a customer requirement table; and
obtaining the price of the product, based on a sum of quotes for the process technologies corresponding to the product, from the customer requirement table.

10. The method as claimed in claim 9, wherein, in the creation step, the original data tables comprise an original product data table and an original process technology table.

11. The method as claimed in claim 10, wherein, in the creation step, the product data tables comprise a process technology table created from the original product data table and the original process technology table.

12. The method as claimed in claim 9, wherein, in the creation step, the original data tables comprise an original quote header table.

13. The method as claimed in claim 12, wherein, in the creation step, the product data tables comprise a product quote header table created from the original quote header table.

14. The method as claimed in claim 9, wherein, in the creation step, the original data tables comprise an original quote item table.

15. The method as claimed in claim 14, wherein in the creation step, the product data tables comprise a product quote item table created from the original quote item table.

16. The method as claimed in claim 9, wherein, in the creation step, the process technology data for the product further comprises at least one specified process technology.

17. A customer quotation system providing product price information to customers, comprising:
a data processing module configured to create a process technology table from an original product data table and an original process technology table, the data processing module further being configured to create a product quote header table from an original quote header table, the data processing module further being configured to create a product quote item table from an original quote item table, the data processing module further being configured to integrate the process technology table, the product quote header table, and the product quote item table for conversion to a customer requirement table; and
a data delivery module coupled with the data processing module, the data delivery module being configured to send the customer requirement table to the customer, the data delivery module further being configured to obtain the price of the product accordingly.

18. The system as claimed in claim 17, wherein the process technology table further comprises at least one specified process technology.

19. A storage medium for storing a computer program providing a method for providing product price information to customers, comprising using a computer to perform the steps of:
creating a plurality of product data tables from a plurality of original data tables, wherein the product data tables comprise process technology data and product quote data;
integrating and converting the product data tables to a customer requirement table; and
obtaining the price of the product, based on a sum of quotes for the process technologies corresponding to the product, from the customer requirement table.

20. The storage medium as claimed in claim 19, wherein the original data tables comprise an original product data table and an original process technology table.

21. The storage medium as claimed in claim 20, wherein the product data tables comprise a process technology table created from the original product data table and the original process technology table.

22. The storage medium as claimed in claim 19, wherein the original data tables comprise an original quote header table.

23. The storage medium as claimed in claim 22, wherein the product data tables comprise a product quote header table created from the original quote header table.

24. The storage medium as claimed in claim 19, wherein the original data tables comprise an original quote item table.

25. The storage medium as claimed in claim 24, wherein the product data tables comprise a product quote item table created from the original quote item table.

26. The storage medium as claimed in claim 19, wherein the process technology data for the semiconductor product further comprises at least one specified process technology.

27. A customer quotation system comprising:
logic configured to create product data tables from original data tables;
logic configured to convert the product data tables to a customer requirement table; and
logic configured to calculate a price of a product, the price of the products being based on a sum of quotes for process technologies that correspond to the product, the price of the product being calculated from information in the customer requirement table.

28. A computer-readable medium comprising:
computer-readable code adapted to instruct a programmable device to create a product data table from an original data table;
computer-readable code adapted to instruct a programmable device to convert the product data table to a customer requirement table; and
computer-readable code adapted to instruct a programmable device to calculate a price of a product, the price of the product being based on a sum of quotes for process technologies corresponding to the product, the price of the product being calculated from information in the customer requirement table.
